(19) United States
(12) Patent Application Publication
(10) Pub. No.: US 2013/0016669 A1
(43) Pub. Date: Jan. 17, 2013

(54) Periodic Access Control

(71) Applicants: Ari Hottinen, Espoo (FI); Jaakko Tapani Peltonen, Espoo (FI); Joni Kristian Pajarinen, Vantaa (FI)

(72) Inventors: Ari Hottinen, Espoo (FI); Jaakko Tapani Peltonen, Espoo (FI); Joni Kristian Pajarinen, Vantaa (FI)

(73) Assignee: Nokia Corporation

(21) Appl. No.: 13/183,876

(22) Filed: Jul. 15, 2011

(51) Int. Cl. H04W 72/04

(52) U.S. Cl. 370/329

(57) ABSTRACT

Methods, apparatus, and program products are presented that perform the following: accessing a periodic finite state controller embodying a set of policies for at least access to one or more wireless resources used for transmission by the apparatus; and using the accessed periodic finite state controller to transmit information using the one or more wireless resources. Methods, apparatus, and program products are presented that perform the following: determining a period based at least on characteristics of a wireless environment; and using at least the determined period and the characteristics, determining a periodic finite state controller embodying a set of policies for at least access to one or more wireless resources used for transmission in the wireless environment by a selected wireless device.

### TECHNICAL FIELD

This invention relates generally to wireless networks and, more specifically, relates to techniques for multiple wireless devices to access a wireless resource space.

### BACKGROUND

This section is intended to provide a background or context to the invention disclosed below. The description herein may include concepts that could be pursued, but are not necessarily ones that have been previously conceived, implemented or described. Therefore, unless otherwise indicated herein, what is described in this section is not prior art to the description in this application and is not admitted to be prior art by inclusion in this section.

Wireless systems typically follow a particular transmission policy that is ‘built into’ the devices. Any fixed transmission policy cannot generally operate efficiently in all network scenarios, and consequently the policy should be adaptive or programmable. Furthermore, the transmission policy should be able to account for the fact that certain network or system parameters are not known or are partially known. Conventionally, e.g., when the transmission rule is not deterministic (as in scheduled access), a transmission policy follows random access rules, as in wireless local area network (WLAN), Aloha, and the like. In systems with several non-deterministic devices, synchronization of transmission opportunities across devices, to avoid collisions between the devices, is an additional concern. If such policies were to be computed ‘on-line’ or adapted, the associated computation should not be too demanding. In addition, the transmission policy should enable both (hybrid) random access type behavior (when uncertainties dominate) and scheduled access (e.g., when the network is known to sufficient degree and/or sufficient signaling is allowed to disseminate required information without excessive delays).

There are currently no systems that meet all of these criteria.

### SUMMARY

The embodiments set forth herein are merely meant to be exemplary.

In an exemplary embodiment, an apparatus includes one or more processors and one or more memories including computer program code. The one or more memories and the computer program code are configured to, with the one or more processors, cause the apparatus to perform at least the following: accessing a periodic finite state controller embodying a set of policies for at least access to one or more wireless resources used for transmission by the apparatus; and using the accessed periodic finite state controller to transmit information using the one or more wireless resources.

In a further exemplary embodiment, a method includes the following: accessing a periodic finite state controller embodying a set of policies for at least access to one or more wireless resources used for transmission by the apparatus; and using the accessed periodic finite state controller to transmit information using the one or more wireless resources.

In an additional exemplary embodiment, a computer program product is disclosed including a computer readable medium bearing computer program code thereon for use with a computer, the computer program code comprising: code for accessing a periodic finite state controller embodying a set of policies for at least access to one or more wireless resources used for transmission by the apparatus; and code for using the accessed periodic finite state controller to transmit information using the one or more wireless resources.

In an exemplary embodiment, an apparatus includes one or more processors and one or more memories including computer program code. The one or more memories and the computer program code are configured to, with the one or more processors, cause the apparatus to perform at least the following: determining a period based at least on characteristics of a wireless environment; and using at least the determined period and the characteristics, determining a periodic finite state controller embodying a set of policies for at least access to one or more wireless resources used for transmission in the wireless environment by a selected wireless device.

In another exemplary embodiment, a method includes performing at least the following: determining a period based at least on characteristics of a wireless environment; and using at least the determined period and the characteristics, determining a periodic finite state controller embodying a set of policies for at least access to one or more wireless resources used for transmission in the wireless environment by a selected wireless device.

In a further exemplary embodiment, a computer program product is disclosed including a computer readable medium bearing computer program code thereon for use with a computer, the computer program code comprising: code for determining a period based at least on characteristics of a wireless environment; and code for, using at least the determined period and the characteristics, determining a periodic finite state controller embodying a set of policies for at least access to one or more wireless resources used for transmission in the wireless environment by a selected wireless device.

### BRIEF DESCRIPTION OF THE DRAWINGS

In the attached Drawing Figures:

FIG. 1 illustrates a simplified block diagram of various electronic devices and apparatus that are suitable for use in practicing the exemplary embodiments of this invention.

FIG. 2A is a block diagram of a method for determining and using periods in accordance with an exemplary embodiment of the instant invention.

FIG. 2B is a block diagram of another method for determining and using periods in accordance with an exemplary embodiment of the instant invention.

FIG. 3A is an influence diagram for a decentralized partially observable Markov decision process (DEC-POMDP) with finite state controllers \vec{q}, states s, joint observations \vec{o}, joint actions \vec{a}, and reward r (given by a reward function R_{s(t)\vec{a}(t)}), where a dotted line separates two time steps.

FIG. 3B represents an example of a new periodic finite state controller. The controller has three layers, has three nodes in each layer, and possible transitions are shown as arrows. Each layer is a vertical column and is depicted inside a corresponding box. The controller controls one of the agents (e.g., a wireless device). Which layer is active depends only on the current time; which node is active and which action is chosen depend on transition probabilities and action probabilities of the controller.

FIGS. 4 and 5 illustrate an example set of policies to access wireless resources that is implemented by two devices.

FIGS. 6 and 7 illustrate an example policy for the same situation as in FIGS. 4 and 5, but now the policies include randomness for allowing devices to transmit sometimes.

FIG. 8 is an example of a stochastic policy for a wireless device.

FIG. 9 is a table illustrating DEC-POMDP benchmarks. Results for comparison purposed are from the following: C. Amato, D. Bernstein, and S. Zilberstein, “Optimizing Memory-Bounded Controllers for Decentralized POMDPs”, in Proc. of 23rd UAI, pages 1-8 (2007); C. Amato, B. Bonet, and S. Zilberstein, “Finite-State Controllers Based on Mealy Machines for Centralized and Decentralized POMDPs, in Proc. of AAAI Conference on Artificial Intelligence (2010); C. Amato and S. Zilberstein, “Achieving goals in decentralized POMDPs”, in Proc. of 8^{th} AAMAS, volume 1, pages 593-600 (2009). Note that “Goal-directed” is a special method that can only be applied to problems having goals.

FIG. 10 is a table illustrating POMDP benchmarks.

### DETAILED DESCRIPTION OF THE DRAWINGS

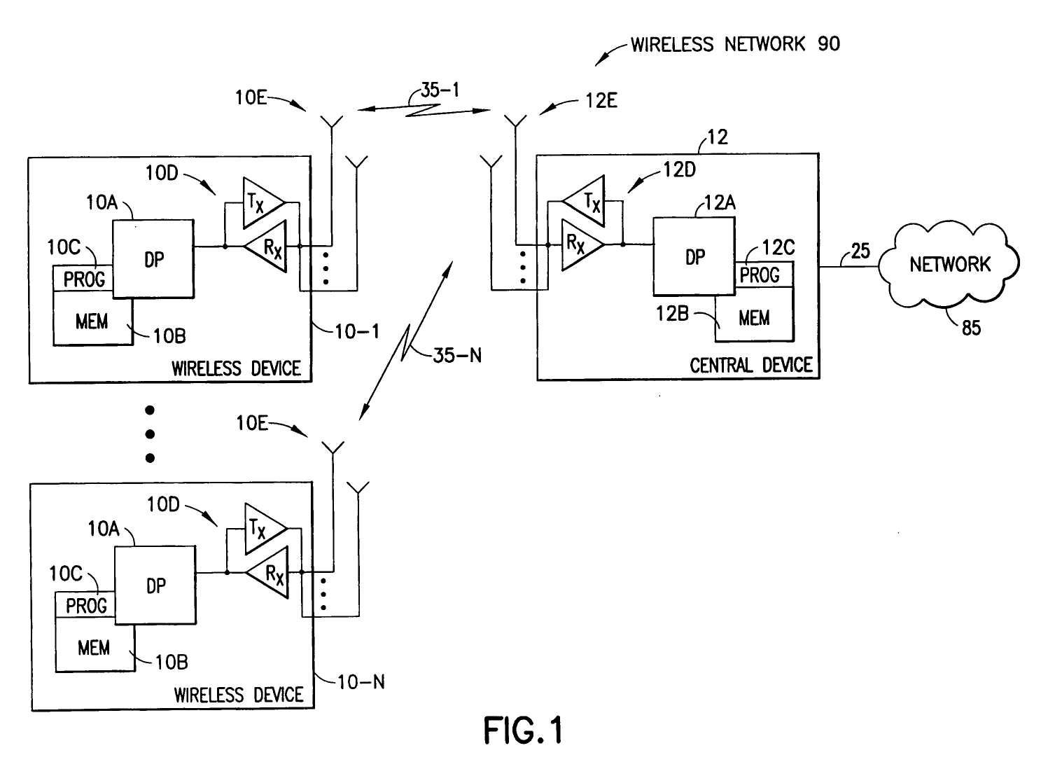

Before describing in further detail the exemplary embodiments of this invention, reference is made to FIG. 1 for illustrating a simplified block diagram of various electronic devices and apparatus that are suitable for use in practicing the exemplary embodiments of this invention. In FIG. 1, a wireless network 90 is adapted for communication over wireless links 35-1 through 35-N with a “central” wireless device 12. The central wireless device 12 in this example provides connectivity with a further network 85, such as a data communications network (e.g., the Internet), via a link 25.

The wireless device 10 includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) transmitter and receiver pair (transceiver) 10D for bidirectional wireless communications with the central wireless device 12 via one or more antennas 10E (typically several when multiple input/multiple output (MIMO) operation is in use). The central wireless device 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas 12E (typically several when multiple input/multiple output (MIMO) operation is in use).

In an exemplary embodiment, the wireless network 90 is decentralized and the “central” wireless device is used to communicate certain periodic information to the other wireless devices.

At least one of the programs 10C and 12C are assumed to include program instructions that, when executed by the associated DP 10A, 12A, enables the corresponding wireless devices 10, central wireless device 12 to operate in accordance with the exemplary embodiments of this invention, as will be discussed below in greater detail. The exemplary embodiments of this invention may be implemented at least in part by computer software executable by at least one of the data processors, or by hardware (e.g., an integrated circuit defined to carry out one or more of the operations described herein), or by a combination of software and hardware.

In general, the various embodiments of the UE 10 can include, but are not limited to, cellular phones, personal digital assistants (PDAs) having wireless communication capabilities, tablets having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B and 12B may be of any type suitable to the local technical environment and may be implemented using any suitable data storage device and corresponding technology, such as semiconductor based memory devices, random access memory, read only memory, programmable read only memory, flash memory, firmware, microcode, magnetic memory devices and systems, optical memory devices and systems, fixed memory, and removable memory. The data processors 10A and 12A may be of any type suitable to the local technical environment, and may include one or more of general purpose computers, special purpose computers, microprocessors, digital signal processors (DSPs) and processors based on multi-core processor architectures, as non-limiting examples.

Now that exemplary apparatus and a system have been described, a more detailed description of the exemplary embodiments is described. The instant invention includes, in exemplary embodiments, systems and methods for dynamically gathering and sharing information of periodicity in a communication environment and exploiting the information for choosing access policies for several communicating devices (that is, cognitive radio systems with multiple users). Generally, in an exemplary embodiment, the instant invention intelligently gathers information about periodicity in communication, shares the information between devices, and exploits the information for optimization of access and sensing policies, typically by computationally complicated methods of probabilistic modeling and optimization.

Specifically, it is noted that optimal access (and sensing) policies are dependent on the particular communication situation (the set of communicating devices, the pattern by which their input buffers fill up, the degree of interference they cause to each other, and so on). It is also noted that constructing optimal access policies for each situation is a challenging computational task where current reinforcement learning based methods are not good enough. It is further noted that adopting a periodic structure for probabilistic modeling of channel occupancies can help a suitable reinforcement learning method find better optima (e.g., better access policies) than optimization without any assumed structure. It is then noted that if the assumed periodic structure is chosen to be as informative as possible about the real communication situation, then this should help optimization even more, leading to even better access policies. It is then suggested to use several ways of sharing information between devices, or between central devices and other devices, to provide each device with the best available information for making good assumptions about periodic structure in the communication. It is lastly noted that the assumption of periodic structure can also be used to conveniently assign and communicate rules of behavior inside the period to devices.

The techniques presented herein share some characteristics of earlier techniques, but the new techniques are not a hybrid of existing solutions; instead, the new techniques include new methods that have some of the same capabilities as earlier methods, and yet have improvements even on the level of individual concepts. The basic concepts of sensing, channel reservation, and traffic profiles are naturally used in the new techniques too, but the manner in which access policies are constructed is improved. In particular, in an exemplary embodiment, optimization of partially observable Markov decision process (POMDP) and decentralized POMDP (DEC-POMDP) based policies based on intelligent restrictions where periodic state transitions are required is an improved technical solution, and an efficient example implementation of the optimization is proposed as an algorithm (see the more thorough description given below).

In terms of motivation for the instant invention, coexistence of several devices that perform wireless communication is easier if wireless devices can anticipate each other's communication needs, to avoid collisions over a limited amount of available radio spectrum. Direct communication between the devices to inform each other about their intentions would consume radio spectrum and other resources like power; such direct communication should therefore be kept minimal.

There exist computational methods, for example decentralized partially-observable Markov decision policies (DEC-POMDPs), which can optimize action policies for several devices that have a joint objective but do not communicate directly. Such methods can optimize policies to maximize several different objectives by assigning different rewards/penalties to possible outcomes of actions. For example, expenditure of energy and transmission collisions can be penalized whereas successful transmissions can be rewarded, and the degree of importance of each type of outcome can be adjusted by adjusting the scale of the rewards/penalties. Such optimized policies can be called cognitive in the sense that the policies have been optimized for a particular communication situation. However, optimizing such policies is computationally demanding and the devices require many observations of historical communications to detect useful patterns in each other's behavior.

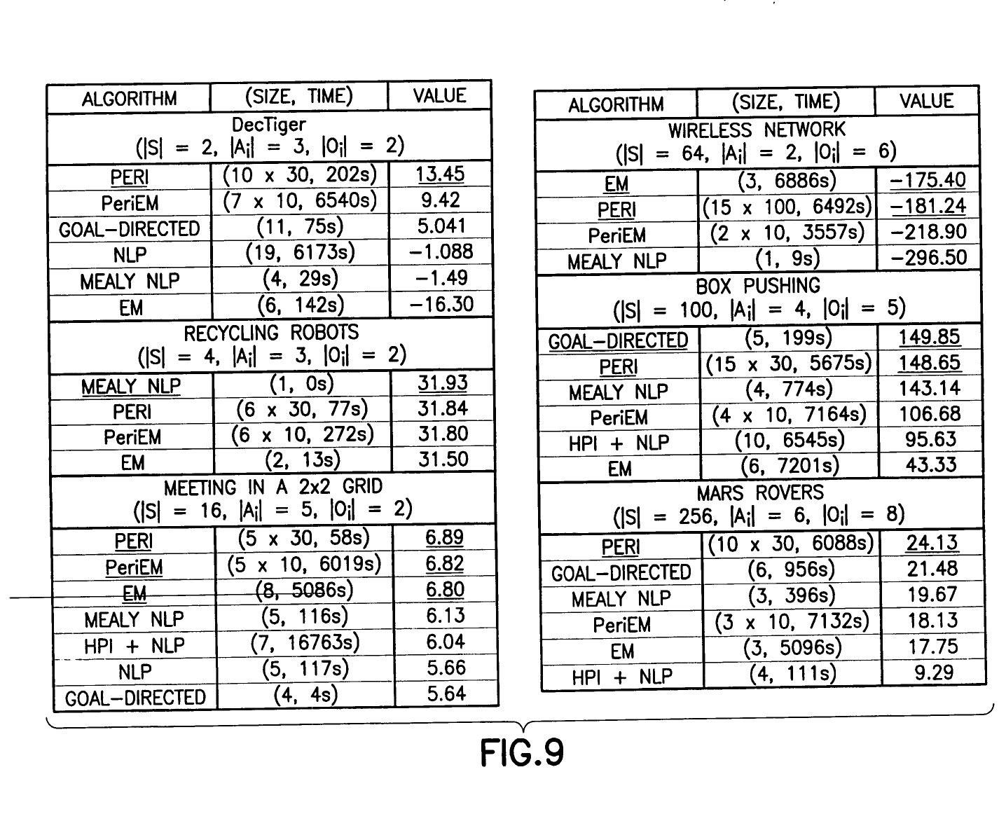

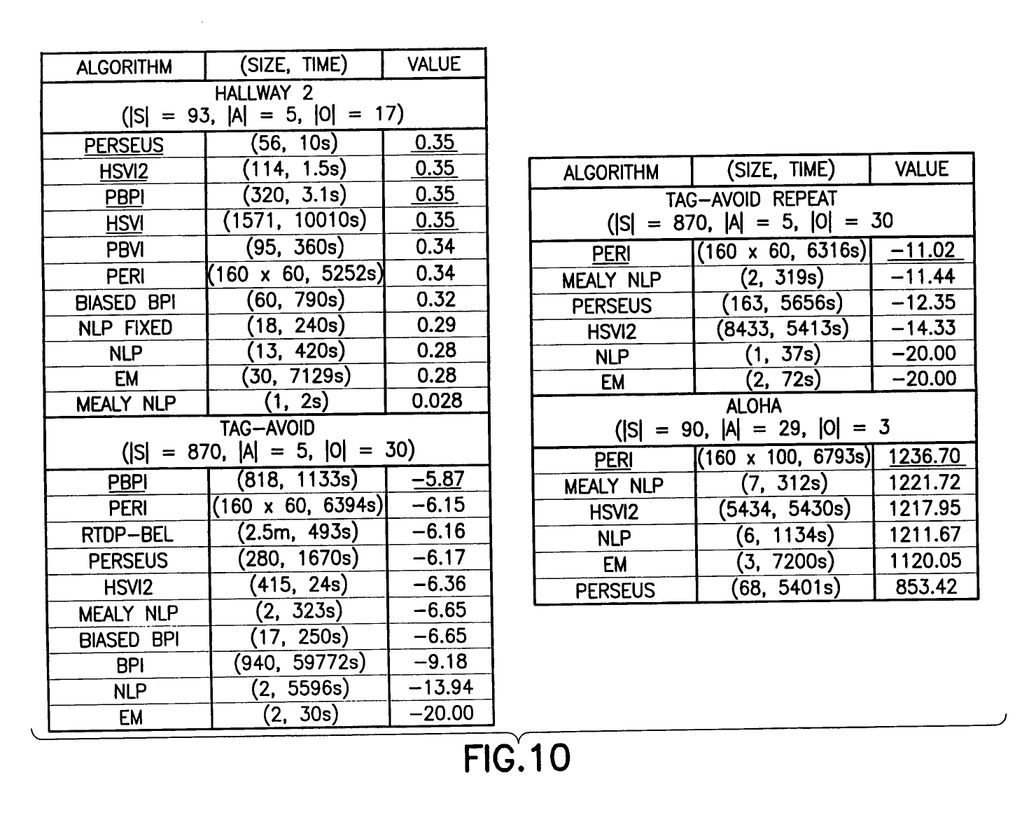

Regarding intelligent restriction of optimization for improved cognitive access policies, restricting the structure of the models (DEC-POMDPs) intelligently can help restrict the optimization so that the optimization can reach better solutions in a finite time. In an exemplary embodiment of the instant invention, the models are restricted to use periodic structure. Concrete experiments are presented (see discussion of FIGS. 9 and 10, below) showing that, in the real-life scenario of finite computational resources, DEC-POMDP policies optimized with a periodic structure lead to better channel access (e.g., fewer collisions between communicating devices, more data successfully transmitted, fewer delays overall) than policies optimized without such structure. This is because the optimization of policies is a highly complicated machine-learning problem, and policy optimization methods that do not use intelligently restricted structure will not reach a good enough solution in a finite time. This is proof that adding an intelligently chosen period structure will help optimization of access policies. As part of an exemplary embodiment, an example implementation of optimizing channel access policies using a periodic structure is provided. The implementation is a new computational algorithm described in more detail below.

Regarding gathering, distributing, and exploiting information for intelligent restrictions, since restriction of models by assuming a period structure can help optimization, it then naturally follows that when devices optimize access policies, the goodness of the resulting access policies will depend on how good the period structure used by the devices is. A period structure that follows actually occurring periodicity in the communication environment should be a better restriction than an artificial structure that does not match real communication patterns.

In an exemplary embodiment of the invention, it is therefore considered beneficial to have a structure of communication between devices for processing and distributing periodic information, so that devices can exploit the periodic structure. Not every cell phone or other wireless device has access to information crucial to determining a successful periodic access policy. For example, an individual device may not be able to detect all primary or secondary users that can be disturbed by the communication. Sharing periodic information between a central device and others helps in this. The invention thus provides a system for sharing and exploiting periodic information among devices with stochastic (e.g., cognitive) access policies. In an exemplary embodiment, the invention proposes an arrangement of devices where a central device, which often has long-term information of communication at some location, determines the periodic structure and communicates the periodic structure to client devices, or the central device communicates sufficient information that the client devices can choose a good structure. An exemplary embodiment therefore discloses a system of dynamically choosing access policy period information for several communicating devices.

With regard to applying further behavior restrictions within periods, a period is divided into several time intervals of typically different lengths. An exemplary embodiment of the invention includes the ability to restrict behavior of devices within each time interval inside their periodic access policy. This restriction is not mainly to improve on current access policies designed for current situations, but rather to take into account future needs: as cognitive policies become allowed, restrictions may be set into place to prevent cognitive devices from excessively disturbing primary users. Business reasons may also prevent cognitive devices from behaving freely. It is likely that for several types of primary users, or for several types of business reasons, restrictions to cognitive devices could follow a periodic pattern, for example, a television station transmitting at certain times may require no cognitive radio transmissions during those times. An exemplary embodiment of the instant invention shows how, in one example, a central device (which has available knowledge of the restrictions) can communicate periodic restrictions of behavior to individual devices. This is not the same as simply scheduling access, as the communication tells devices, for example, when the devices can use cognitive methods for the access rather than falling back to a standard protocol.

At this point, a clarifying note is provided on the meaning of “access” to wireless resources herein, and relationship of this term to other conventional schemes. A wireless resource may be, e.g., a channel, a set of time-frequency resources, frequency resources, time resources, and the like. The exemplary embodiments apply the proposed methods in connection with WLAN or future cognitive radio access schemes. Third generation partnership project (3GPP) random access schemes, while some of the same vocabulary is used as in, e.g., WLAN, refers to random access within cellular systems (e.g., initial access, etc.). Typically, in long-term evolution (LTE) and high-speed packet access (HSPA), efficient channel-aware scheduling is used when synchronization and channel-awareness is in place, but only initial access (when one or multiple mobile devices can attempt access simultaneously) typically resembles the situations described herein. The initial access is certainly dimensioned on the safe side always, since this access incurs only a small loss in total capacity (and coverage optimization clearly dominates design).

In the instant document, it is assumed that the system is more decentralized, and that the network does not have the luxury of over-dimensioning for all traffic (e.g., as over-dimensioning simply reduces efficiency). Rather, with decentralized access, all information learnable from measurements and the like are used to improve efficiency.

The proposed schemes do not restrict the use of channel-aware scheduling. Instead, channel-aware scheduling could be one of the access schemes to wireless resources (e.g., a channel) that the method learns to use in some situations. Channel-aware scheduling relies on accurate channel knowledge, and is only beneficial when accurate channel knowledge exists. One mode of the instant invention is to learn transition probabilities between different access schemes: devices can learn to choose between existing alternative access schemes as part of learning the access policy, by providing the access schemes among the options available for the devices during policy optimization. Behavior restrictions, sent for example from a central device, can be used to restrict which access schemes are allowed at each time.

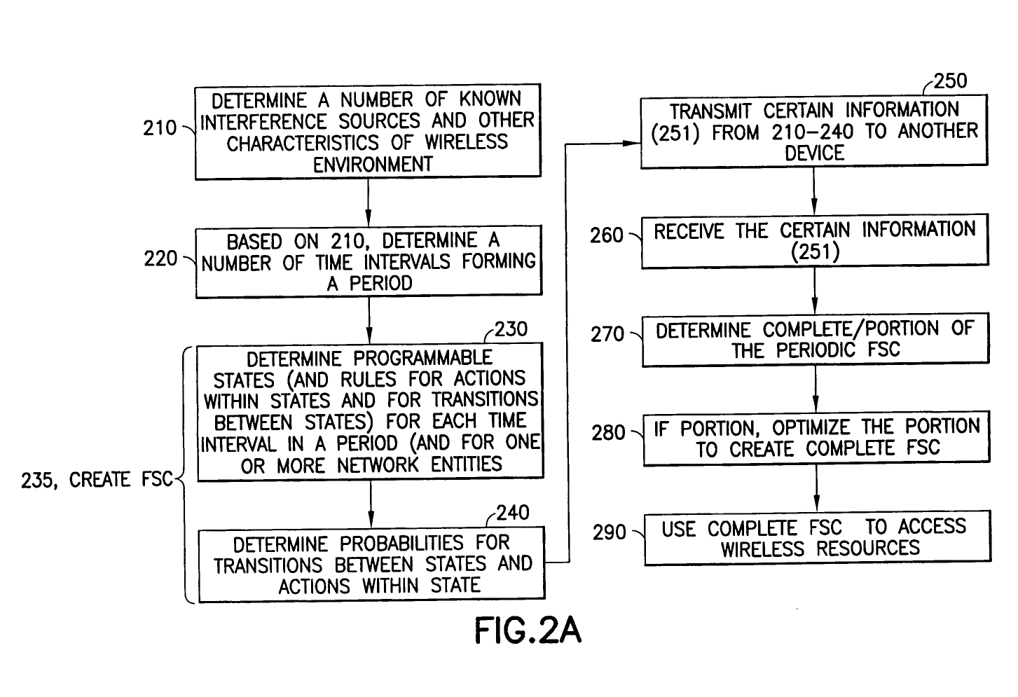

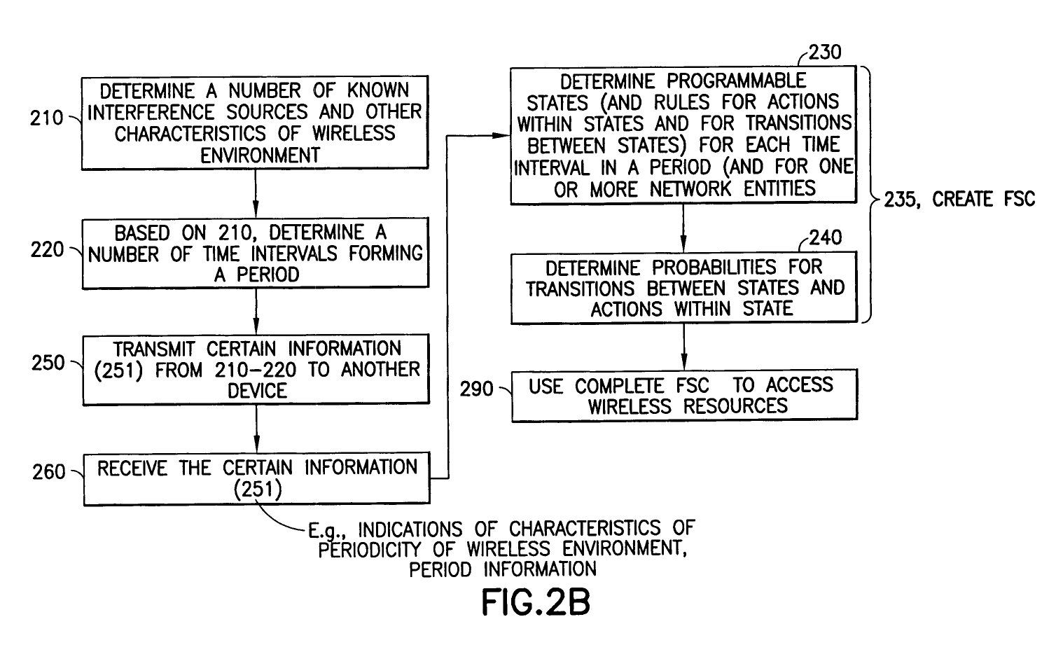

Turning to FIG. 2A, a block diagram is shown of a method for determining and using periods in accordance with an exemplary embodiment of the instant invention. In block 210, a number of known interference sources (as examples of characteristics of a wireless environment) are determined. Some of the interference sources may have a periodic interference pattern, or a stochastic interference pattern that has periodic properties. Some of the interference sources can be external such as television (TV) stations, and some of the interference sources may be internal, meaning that some of them are wireless systems whose behavior is controlled by techniques of this invention. That is, the term “internal” in this instance means a wireless device is internal to a system using an embodiment of the instant invention if the wireless device is controlled by the techniques presented herein (e.g., techniques that involve optimization of periodic finite state controllers). External means devices that do not implement the techniques presented herein. External devices can be part of the same wireless network, e.g., a standard 802.11 device. Both internal and external devices create interference (which can often not be distinguished based purely on observations), but a system using the instant invention can influence the behavior of internal devices and thus influence the interference caused by these devices.

In block 220, using the information from block 210, a number is determined of time intervals forming a period (to be repeated).

In block 230, programmable states (e.g., and rules for actions within states and for transitions between states) are determined for each time interval in a period and potentially for one or more network entities (e.g., devices, services, etc.). For at least two intervals in said period, each of these intervals comprises one or more states, and further there are at least partially different states in different intervals. States in one periodic interval are resumed when one period has lapsed. States in interval t can be followed only by states in interval t+1 or may be preceded only by states in interval (t−1).

In block 240, probabilities are determined for transitions between states and actions within states. The transitions and actions are at least partially stochastic, typically with programmable transition and action probabilities. Transition and action probabilities may be learned using network measurements. It is noted that the end result of blocks 230 and 240 should be creation of a periodic finite state controller (block 235).

Some of operations 210-240 may be performed in a central device 12, and others in wireless device(s) 10 that are in occasional or frequent contact with the central system. Alternatively, any of operations 210-240 may be performed jointly by the central device 12 and by wireless devices 10 in contact with the central device 12. It is noted that this may also be extended to multiple systems, each having a central device. That is, there may be some communication between the multiple systems to, e.g., communicate periodic interference information and periodic FSC information, and such communications may be used, e.g., for further optimization in each system.

Certain information 251, such as transition and action probabilities and respective states are signaled between network nodes (e.g., from central wireless device 12 to one or more wireless devices 10) in block 250. Rules acquired because of operations 210-240 can be transmitted in block 250 from a central system to wireless systems, or from wireless systems to a central system, or between wireless systems. Alternatively, information 251 obtained in operations 210-240 can be transmitted in block 250 from a central system to wireless systems, from wireless systems to a central system, or between wireless systems, and used by the recipients for forming the rules. The rules, transition and action probabilities, and respective states correspond, in an exemplary embodiment, to a periodic finite state controller (FSC), as described below.

In block 260, a wireless device receives the certain information 251. The wireless device uses (block 270) the certain information to determine a complete or a portion (that is, not all) of the periodic FSC (as described in more detail below). In block 280, if the wireless device received a portion of the periodic FSC, the wireless device can optimize the portion to determine a complete FSC (described in more detail below). It is noted that if block 280 is performed, block 240 might not be performed by the central device or block 240 may only be partially completed. In block 290, the wireless device uses the complete FSC to access one or more wireless resources.

Knowledge of periodic behavior in the group of wireless devices helps the wireless devices find suitable action policies more easily. Periodic behavior means a wireless device is known to change its momentary behavior between a (typically limited) number of possible behaviors, and the change typically occurs at known intervals. The length of time allocated for a certain behavior is called an “interval”, and a sequence of intervals, where a device can progress through several possible behaviors, is called a “period”. Thus, a period consists of a sequence of time intervals. When a period ends, the period starts from the beginning. For example, a central system can communicate period lengths and interval information to other wireless systems or devices. The central system can learn period lengths from experience or use predefined rules to determine these lengths or use rules to guide the learning of the period lengths. Interval information can be rules, probabilities or any other kind of model.

Interval actions are defined as rules of operation of a wireless device, e.g., transmit, receive, or measurement action, of particular type, or even one of obeying a particular communication protocol (e.g., one action can be ‘operate according to 802.11’ and another ‘operate according to 3GPP LTE’). Furthermore, the actions can be programmed to avoid a particular type of service, or to co-exist as well as possible with another service.

The wireless environment of the devices can also have periodic behavior, and often it will be useful to synchronize changes in device behavior to changes in behavior of other devices and changes in environment behavior. In this invention, a central system communicates period lengths and interval information to other wireless systems or devices. Devices receive, from the central system, data of known periodicity of the environment and data of known periodicity of other devices. Each device then optimizes its behavior using that information. The central system can also specify rules of behavior for each period. For example, the central system may instruct devices to avoid TV channels in periods where the central system knows of ongoing TV broadcasts, or to fall back to a standard behavior protocol in periods where business agreements prevent deviations from that behavior.

Monetary (or other) rewards can be incorporated into periodic rules, which a central system transmits to wireless devices. For example if the transmission of a certain traffic class is cheaper at certain times, this information can be encoded into the periodic information transmitted to the wireless devices. The central system can therefore optimize the system for inexpensive transmissions when choosing rules for each of the wireless devices. Additionally, the devices can then consider the monetary information while acting according to the transmitted rules. For example, if a choice is available to the user within the permitted behavior rules, the devices can display to the user the transmission cost for each choice and allow the user to select between the choices.

The central system can learn the overall length of a period, the number of distinct intervals within a period, and the lengths of the intervals, from experience, or the central system can use predefined rules to determine the period lengths, interval numbers, and lengths, or use rules to guide the learning of the period lengths, interval numbers, and lengths. For each interval, the central system can store and communicate to the devices, information guiding and regulating behavior within the interval, which can be rules, probabilities or any kind of model.

A number of exemplary use cases are now presented. For a first exemplary use case (“Case 1”), periodicity is utilized in optimization and synchronization of wireless devices. A central system collects information about the radio environment and location of the wireless devices, computes a periodic policy for each device, and communicates the policies to the wireless devices. Policy refers here to a possibly stochastic conditional plan: in each time interval, a wireless device makes an observation, chooses one or more actions according to a probability distribution determined by the current policy and the observation, and then adjusts policy information using the received observation. An observation is any sensory input, such as channel power level. If there are two potentially interfering wireless devices, a periodic policy can force the devices to transmit in different time intervals (that is, in non-overlapping intervals of the period) or the policy can force the devices to randomly transmit data. This use case uses periodicity and period-related information to create stochastic periodic policies by, e.g., complicated optimization methods such as reinforcement learning.

For a second exemplary use case (“Case 2”), the central system keeps up-to-date information about sources of interference that have a known schedule, such as television programs, and conveys an associated model to other communication devices. In the television case, the period could be one day and each time interval is the length of a television program. The rule for a time interval is then “don't transmit” or “channel free”, so as not to interfere with a transmission of a particular TV program. Probabilistic information on the use of particular TV channels in a particular area is included in transition rules in respective intervals. The periodic information is transmitted to several wireless devices, which are required to optimize their behavior using the periodic information (that is, to transmit only in intervals where the channel has been indicated to be free or transmit only when the probability of interference, according to the probabilistic model of TV channel use, is small enough). This allows wireless devices to avoid interfering with broadcast transmissions.

It is clear from the use cases presented above that the exemplary embodiments of the instant invention are also applicable to future systems where devices are allowed to design access policies that can at least partly deviate from current protocols. Several ways to implement the invention are described below, and each of these implementations affects the information delivery mechanism.

1. A central device, like a base station, could observe communications over a long period, and detect periodicity in such communication. Such detection could be, for example, by fitting a rough periodic probabilistic model to the observed data (known information of periodicity of some transmissions, for example television broadcasts or other agreed-upon primary user activity, can be rigorously taken into account in such fitting). The central device could then optimize the fit with respect to the structure of the periodicity (e.g., length of the period, number of different intervals within the period, and lengths of each interval; or even several superimposed periods with different lengths and numbers and lengths of intervals). The result of the fitting is a model of periodicity: at simplest, the model can simply be a length of the period (“5 minutes 13.176 seconds”), reference starting point “13:30:02:025 UTC”, where UTC is coordinated universal time), number of intervals (“6”) and their lengths (e.g., one number for each interval, summing up to the period length). That is, the central device performs all of blocks 210-240 above.

2a. Individual wireless devices, like cell phones, would, upon their first contact with the base station (the central device in this example), be transmitted the above information in an agreed-on format. Each wireless device would then use the received description of the periodicity of characteristics of the wireless environment (and a corresponding period) as an assumption for building and optimizing a model such as a POMDP, which yields an access policy, based on building a probabilistic model of communication from observations. This is illustrated by FIG. 2B, where the central device performs blocks 210, 220, and 250 and transmits information 251 to a wireless device. The information 251 can include indications of a description of the periodicity of characteristics of the wireless environment (and, e.g., corresponding period information). The wireless device then performs operations 260, 230, 240, and 290 in FIG. 2B.

2b. Instead of 2a, where each individual device optimizes a policy separately, the devices could communicate their intended communication needs (e.g., a probabilistic model of how their input buffer fills up, described for example as a Markov model) to the central device. The central device, based on the probabilistic input-buffer models of all devices and based on the periodicity information the central device estimated in step 1, could then build and optimize a model such as a DEC-POMDP, which yields a policy for each of the individual devices. The central device would then communicate the policy (embodied in a FSC) of each individual device back to that device based on an agreed-on encoding. See FIG. 2A.

2c. Instead of 2a or 2b, part of the optimization of the policy could be performed at a central device and part at individual devices. In this case, individual devices still communicate their communication needs to the central device as in 2b. However, the central device does not optimize a complete set of policies. Instead, the central devices optimizes a partial set of policies in blocks 230 to 240 of FIG. 2A that is, e.g., either a fully formed DEC-POMDP based set of policies but not optimized all the way, or (as another non-limiting example) a set of additional information useful for optimizing the set of policies (for example, an identification of which devices would most likely conflict, and an expected collision pattern). In either of these exemplary cases, the information 251 is sent to the individual devices in an agreed-on format, and the individual devices then continue the optimization (see block 280 of FIG. 2A). It is noted that a set of policies can be a single policy or multiple policies.

2d. Instead of 2a, 2b, or 2c, where a central device is involved, individual devices could cooperate with detected nearby other devices, sending information about observed periodic behavior and about communication needs to each other. Each individual device could then integrate the information the device has received and optimize a POMDP policy as in 2b.

Alternatively, each device could try to optimize a DEC-POMDP policy for all nearby devices; such policies would be sent to other devices and each device would then integrate all versions of its policy, both the one the device optimized itself and the ones received from nearby devices. Version 2d would involve the nearby devices contacting each other in an agreed-on way soon after entering the vicinity of each other. Version 2d can also occur concurrently with a central device based version (2a, 2b, or 2c).

In 2a, 2b, and 2c, known rules about behavior within each interval of the period can be transmitted along with the periodicity information or with the computed policies (or the ‘additional information useful for optimizing the policy’ in 2c), again with some agreed-on encoding. In 2b and 2c, the optimization of policies that continues within the receiving devices will then integrate the received rules as constraints within the optimization.

The specific transmission protocol of how the above-described information is encoded and sent can vary without falling outside the current invention. Furthermore, instead of a POMDP or DEC-POMDP model, any other suitable model can be used with a corresponding encoding of the information used by the model and the resulting access policy.

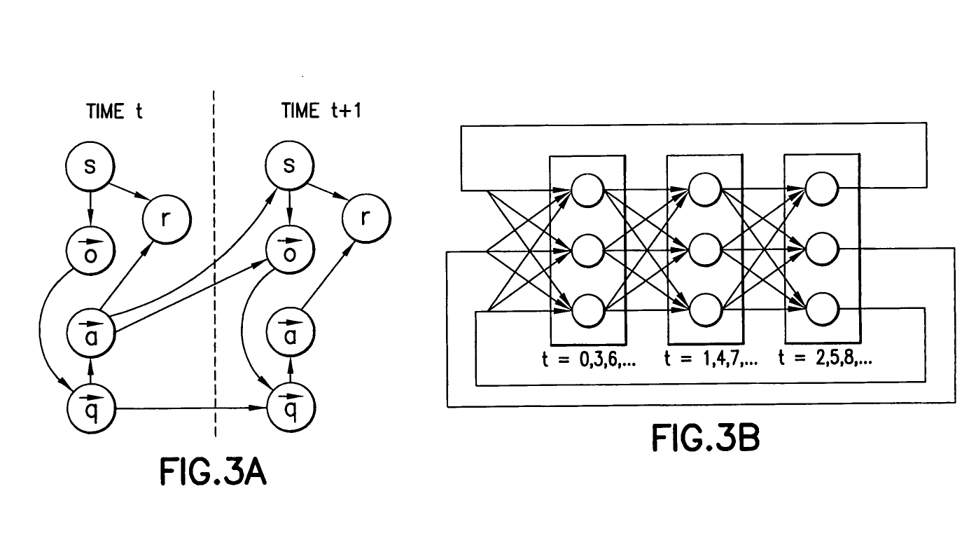

Details of implementing specific cases are presented next. Regarding implementing use Case 1, the planning algorithm for generating wireless device policies for single devices can be a partially observable Markov decision process (POMDP) algorithm and for multiple wireless devices a decentralized POMDP (DEC-POMDP) algorithm. The policies can be embodied as stochastic finite state controllers. A (DEC)-POMDP method requires as input a Markov model of the environment and a reward model, which assigns rewards to specific world states. To minimize collisions in wireless networks, a penalty can be assigned to each collision. The Markov model describes the world dynamics. The Markov models of wireless device traffic patterns, the information about how much devices interfere with each other, and a probabilistic observation model for each device can be combined into a Markov model that the (DEC)-POMDP method can use together with the reward model to optimize wireless device policies. The joint policy to be optimized is a set of stochastic finite state controllers (FSCs), one for each agent. A FSC resembles a Markov model, but transitions depend on observations from the environment, and the FSC emits actions affecting the environment. The FSC for agent i is specified by the tuple [symbol] Qᵢ,ν_{q}_{ᵢ},πₐ_{ᵢ}_{q}_{ᵢ},λ_{q′}_{ᵢ}_{q}_{ᵢ}ₒ_{ᵢ} [symbol] , where Qᵢ is the set of FSC nodes qᵢ, ν_{q}_{ᵢ} is the initial distribution P(qᵢ) over nodes, π_{q}_{ᵢ}_{q}_{ᵢ} is the probability P(aᵢ|qᵢ) to execute action aᵢ when in node qᵢ, and λ_{q′}_{ᵢ}_{q}_{ᵢ}ₒ_{ᵢ} is the probability P(q′ᵢ|qᵢoᵢ) to move from node qᵢ to node q′ᵢ when observing oᵢ. See FIG. 3A, which is an influence diagram for a DEC-POMDP with finite state controllers \vec{q}, states s, joint observations \vec{o}, joint actions \vec{a}, and reward r (given by a reward function R_{s(t)\vec{a}(t)}, where a dotted line separates two time steps.

The structure of a (DEC)-POMDP solution can be restricted into a periodic form by forcing the (DEC)-POMDP solution into distinct parts, where each part can be active only at certain (periodic) times. A periodic FSC is a FSC that is composed of M layers of controller nodes. An example of a periodic FSC is shown in FIG. 3B. The controller has three layers, has three nodes in each layer, and possible transitions are shown as arrows. Each layer is a vertical column and is depicted inside a corresponding box. The controller controls one of the agents. An agent is, e.g., a wireless device. Each node corresponds to a state of the agent. Which layer is active depends only on the current time (e.g., corresponding to 0, 3, 6, . . . or to 1, 4, 7, . . . in FIG. 3B); which node is active and which action is chosen depend on transition probabilities and action probabilities of the controller. Each layer is connected only to the layer after it. The first layer is connected to the second layer and the last layer is connected to the first layer. The width of the periodic FSC is the number of controller nodes in a layer. A periodic FSC has different action and transition probabilities for each layer. That is, πₐ_{ᵢ}_{q}_{ᵢ}^{(m)} is the layer m (of M layers) probability to execute action aᵢ when in node qᵢ and λ_{q′}_{ᵢ}_{q}_{ᵢ}ₒ_{ᵢ} is the layer m probability to move from node qᵢ to node q′ᵢ when observing oᵢ.

An example algorithm that can optimize DEC-POMDP or POMDP access policies using periodic information is presented in more detail below.

When device policies are optimized using POMDP or DEC-POMDP methods, rewards can be directly assigned to world states and actions. In an example, a reward r is given by a reward function R_{s(t)\vec{a}(t)}, which shows that the reward function is a function of the state and the action. The rewards can be equal to monetary rewards that the systems actually receive. A device transmitting when the device should not can cause a large negative reward, and a device that transmits a lot of data without causing interference to other devices causes a large positive reward. Because the methods in an exemplary embodiment optimize policies that maximize the total summed reward over many time steps, maximum monetary benefit is accrued.

There are infinitely many different kinds of policies, but two example FSC policies are presently described to highlight some exemplary policy properties. POMDP and DEC-POMDP algorithms can automatically generate the policies needed for different kinds of situations.

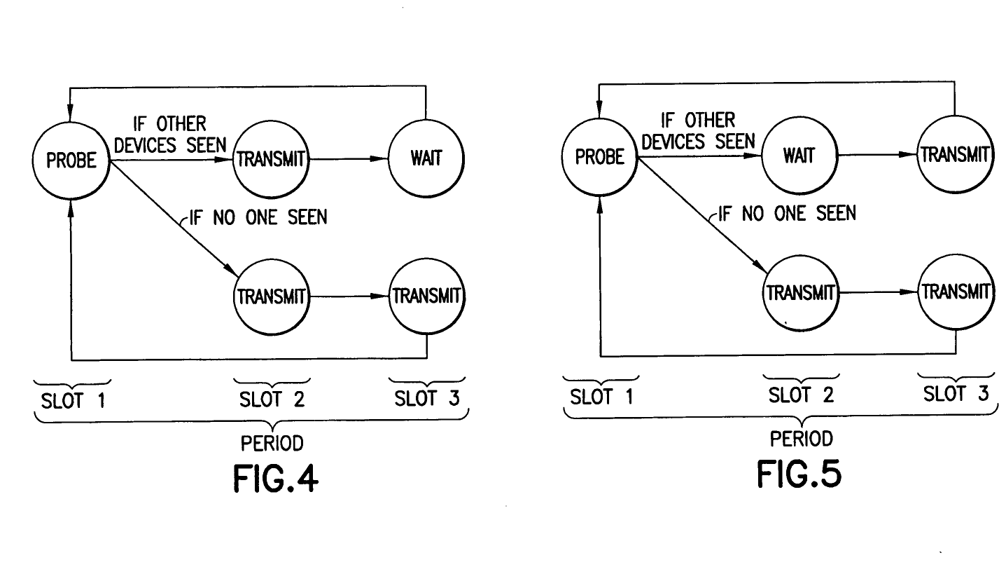

An example of a policy for two wireless devices is shown in FIGS. 4 and 5. FIG. 4 illustrates implementation of the policy for Device 1, and FIG. 5 illustrates the policy for Device 2. The policy for FIGS. 4 and 5 is shown in a periodic FSC form. That is, FIGS. 4 and 5 are periodic FSCs that implement a set of policies to access one or more wireless resources. There are three time slots, each of which is an interval that makes up a period. Additionally, each slot is a layer of the periodic FSC. Device 1 and 2 probe the channel in time slot 1. If the devices detect (in the probe state, which is where sensing of the wireless environment occurs) that there are other devices probing (“if other devices seen”), Device 1 will transmit in slot 2 (see FIG. 4) and Device 2 in will transmit in slot 3 (see FIG. 5), thus preventing collisions. If the devices do not detect other devices (“if no one seen”), both will transmit in both slots 2 and 3 (see FIGS. 4 and 5). This kind of policy can be useful for example if two mobile users move around and at times interfere with each other and at other times do not. The periodicity of the policies is crucial for synchronization of the two devices without communication between the two devices.

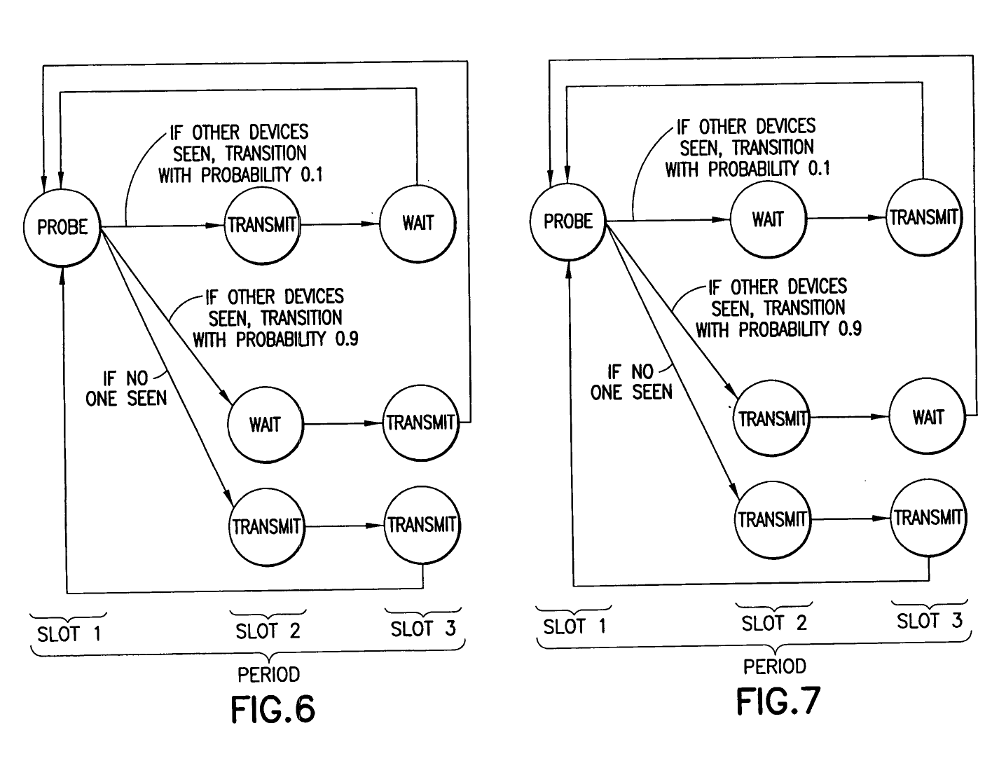

FIGS. 6 and 7 illustrate an example policy for the same situation as in FIGS. 4 and 5, but now the policies include randomness for allowing devices to transmit sometimes. FIG. 6 illustrates implementation of the policy for Device 1, and FIG. 7 illustrates the policy for Device 2. The policy for FIGS. 6 and 7 is shown in a periodic FSC form. That is, FIGS. 6 and 7 are periodic FSCs that implement a policy. There are three time slots, each of which is an interval that makes up a period. Additionally, each slot is a layer of the periodic FSC.

In this example, the wireless device in FIG. 6 transitions from the probe state to either a transmit state (if other devices are seen, where the transition from the probe state to the transmit state has a probability of 0.1) or to a wait state (if other devices are seen, where the transition from the probe state to the wait state has a probability of 0.9). If no one is seen, the wireless device in FIG. 6 transitions from the probe state to a transmit state. Similarly, in FIG. 7, the wireless device transitions from the probe state to either a wait state (if other devices are seen, where the transition from the probe state to the wait state has a probability of 0.1) or to a transmit state (if other devices are seen, where the transition from the probe state to the transmit state has a probability of 0.9). If no one is seen, the wireless device transitions from the probe state to a transmit state.

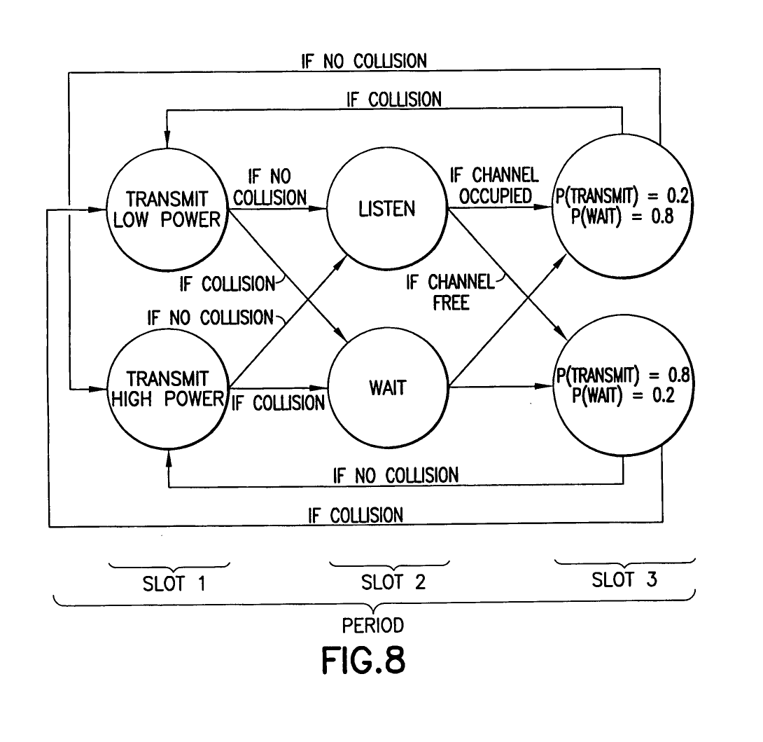

FIG. 8 is an example of a stochastic policy for a wireless device. The stochastic policy for FIG. 8 is implemented using a periodic FSC shown in the figure. There are three time slots, each of which is an interval that makes up a period. Additionally, each slot is a layer of the periodic FSC. There is an environmental factor not shown in the figure, for example TV transmissions or other primary transmitters, that has caused optimization of the depicted policy. The TV transmission may be a primary user of the channel. Other primary users might be wireless microphones or devices that have a priority in using the RF spectrum. The environmental factor has transmissions mostly at time slot 2 and 3, but sometimes also in time slot 1. If there was no collision in time slot 1 and a transmission in low power was made, then the device according to optimized policy in FIG. 8 listens in time slot 2 whether the channel is free. When listening, the transition from slot 2 to slot 3 depends on the observation received from the environment. If the communication channel is observed free, then a transition to a state, where transmission is more likely is performed and if the channel is occupied then a transition to a state where a transmission is less likely is performed. The policy in slot 3 is random access. For example in state 1 of slot 3, the transmission probability is 0.2. This kind of partly random access policy is useful in situations such as where devices cannot be completely synchronized, when devices source traffic intensities vary, or when there is uncertainty about traffic models. A random access policy also guarantees in practice a certain level of throughput. Note that also randomness in state transitions is possible; each observation has a different probability for each possible next state.

If there is a collision while in the state 1 (P(Transmit)=0.2) of slot 3, then a transition is made to state 1 (transmit low power) of time slot 1. Meanwhile, if there is no collision, then a transition is made to state 2 (transmit high power) of time slot 1. If there is a collision while in the state 2 (P(Transmit)=0.8) of slot 3, then a transition is made to state 1 (transmit low power) of time slot 1. Meanwhile, if there is no collision, then a transition is made to state 2 (transmit high power) of time slot 1. Broadly, a policy implemented by the periodic FSC illustrated by FIG. 8 is that transmissions at high power occur if there are no collisions and the channel is free; if there are collisions or the channel is not free, transmissions occur at low power.

Regarding implementing use Case 2, assume a wireless access point that has an Internet connection. The access point uses the Internet connection at 00:00 each day to retrieve the television schedule. The access point uses a period of 24 hours and divides the period into 10-minute time intervals. For each time interval and for each television channel, the access point creates a rule of the form “don't transmit”, “channel free”. The access point transmits the periodic information rules to wireless devices that have a connection with the access point using push or pull methodologies. A wireless device uses the periodic information to transmit on TV channels that are not in use or if all TV channels are in use, the device can transmit on some other free channels. With this information, devices can avoid collisions with TV transmissions even if the devices themselves are not able to detect such collisions.

Use Case 2 can be implemented by forcing part of the states in the partly stochastic policy to perform ‘non-interfering’ actions. For example, in FIG. 8, the policy performs only listen or waiting actions in the second slot.

Even if the broadcast system transmits on the channel, but no one is listening to that channel, in the particular area, the channel can be deemed free. Thus, the probabilistic information can also include information on use of particular channels. Then, the wireless system can use channels that are not actually received with higher probability than more popular channels. The usage pattern for different channels and different receivers can be learned via feedback information (e.g., using a broadcast feedback channel in digital video broadcasting, DVB).

A detailed example of how periodic information might be used to create access policies and how to determine good access policies is now presented. This example uses headings for ease of reference.

Infinite-Horizon DEC-POMDP: A Definition

The tuple [symbol] {αᵢ},S,{Aᵢ},P,{Ωᵢ},O,R,b₀,γ [symbol] , defines an infinite-horizon DEC-POMDP problem for N agents αᵢ, where S is the set of environment states, and Aᵢ and Ωᵢ are the sets of possible actions and observations for agent αᵢ. A POMDP is the special case when there is only one agent. The function P(s′|s,\vec{a}) specifies the Markovian evolution of the environment, that is, the probability to move from state s to state s′, given the actions of all agents (jointly denoted \vec{a}= [symbol] a₁, . . . , a_{N} [symbol] ). The observation function O(\vec{o}|s′,\vec{a}) is the probability that the agents observe \vec{o}= [symbol] o₁, . . . , o_{N} [symbol] , where oᵢ is the observation of agent i, when actions \vec{a} were taken and the environment transitioned to state s′. The initial state distribution is b₀(s). R(s,\vec{a}) is the real-valued reward for executing actions \vec{a} in state s. For brevity, transition probabilities given the actions are denoted by P_{s′s\vec{a}}, observation probabilities are denoted by P_{\vec{o}s′\vec{a}}, reward functions are denoted by R_{s\vec{a}}, and the set of all agents other than i are denoted by ī. At each time step, agents perform actions, the environment state changes, and agents receive observations. The planning optimizes a joint policy π for the agents by maximizing the expected infinite horizon reward discounted by factor γ. In other words, maximize E└Σₜ₌₀^{∞}γ^{t}R_{s(t)\vec{a}(t)}|π┘, where s(t) and \vec{a}(t) are the state and action at time t (respectively), and E[•|π] denotes expected value under the policy π.

The policy is stored as a set of stochastic FSCs, one for each agent. The FSC of agent i is defined by the tuple [symbol] Qᵢ,ν_{q}_{ᵢ},πₐ_{ᵢ}_{q}_{ᵢ},λ_{q}_{ᵢ}_{q}_{ᵢ}ₒ_{ᵢ} [symbol] , where Qᵢ is the set of FSC nodes qᵢ, ν_{q}_{ᵢ} is the initial distribution P(qᵢ) over nodes, πₐ_{ᵢ}_{q}_{ᵢ} is the probability P(aᵢ|qᵢ) to perform action aᵢ in node qᵢ, and λ_{q′}_{ᵢ}_{q}_{ᵢ}ₒ_{ᵢ} is the probability P(q′ᵢ|qᵢ,oᵢ) to transition from node qᵢ to node q′ᵢ when observing oᵢ. The current FSC nodes of all agents are denoted \vec{q}=<q₁, . . . , q_{N}>. The policies are optimized by optimizing the parameters ν_{q}_{ᵢ},πₐ_{ᵢ}_{q}_{ᵢ}, and λ_{q′}_{ᵢ}_{q}_{ᵢ}ₒ_{ᵢ}. FIG. 3A illustrates the setup.

Periodic Finite State Controllers

Algorithms for optimizing POMDP/DEC-POMDP policies with restricted-size FSCs typically find a local optimum. A well-chosen FSC initialization could yield better solutions, but initializing (compact) FSCs is not straightforward: one reason is that dynamic programming is difficult to apply on generic FSCs. FSCs for POMDPs may be built using dynamic programming to add new nodes, but this yields large FSCs and cannot be applied on DEC-POMDPs as it needs a piecewise linear convex value function. Also, general FSCs are irreducible, so the distribution over FSC nodes is not sparse over time even if a FSC starts from a single node. The term periodic FSCs is introduce, and the periodic FSCs can yield improved POMDP and DEC-POMDP solutions.

A periodic FSC is composed of M layers of controller nodes. Nodes in each layer are connected only to nodes in the next layer: the first layer is connected to the second, the second layer to the third and so on, and the last layer is connected to the first. The width of the periodic FSC is the number of controller nodes in a layer. Without loss of generality, it is assumed that all layers have the same number of nodes (although the invention is not limited to this). A periodic FSC has different action and transition probabilities for each layer. πₐ_{ᵢ}_{q}_{ᵢ}^{(m)} is the layer m probability to take action aᵢ when in node qᵢ, and λ_{q′}_{ᵢ}_{q}_{ᵢ}ₒ_{ᵢ}^{(m)} is the layer m probability to move from node qᵢ to q′ᵢ when observing oᵢ. Each layer connects only to the next one, so the policy cycles periodically through each layer: for t≧M we have πₐ_{ᵢ}_{q}_{ᵢ}^{(t)}=πₐ_{ᵢ}_{q}_{ᵢ}^{(t mod M)} and λ_{q′}_{ᵢ}_{q}_{ᵢ}ₒ_{ᵢ}^{(t)}=λ_{q′}_{ᵢ}_{q}_{ᵢ}ₒ_{ᵢ}^{(t mod M)} where ‘mod’ denotes remainder. FIG. 3B shows an example periodic FSC.

A method is now introduced for solving (DEC-)POMDPs with periodic FSC policies. The periodic FSC structure is shown to allow efficient computation of deterministic controllers, and it is also shown how to optimize periodic stochastic FSCs with a periodic deterministic controller as initialization. The algorithms are discussed in the context of DEC-POMDPs, but can be directly applied to POMDPs.

Initialization of Periodic FSCs by Deterministic Controllers.

In a deterministic FSC, actions and node transitions are deterministic functions of the current node and observation. A well-optimized deterministic FSC policy can be a good initialization for more general non-deterministic (stochastic) policies. This approach is taken herein, and it is shown how to efficiently compute deterministic periodic policies. These are used as initializations for stochastic periodic FSCs.

To optimize deterministic periodic FSCs, first a non-periodic finite-horizon policy is computed. The finite-horizon policy is transformed into a periodic infinite-horizon policy by connecting the last layer to the first layer; the resulting policy is still deterministic. This initial policy can be improved first in the deterministic framework if desired (see “Deterministic infinite-horizon controllers” below)). The policy is then used as the starting point for a stochastic FSC optimizer based on expectation maximization (see “Stochastic infinite-horizon controllers and expectation maximization training” below).

Deterministic Finite-Horizon Controllers

Existing methods are briefly discussed for deterministic finite-horizon controllers and an improved finite-horizon method is introduced. This method is used as an initial solution.

Many point based finite-horizon DEC-POMDP methods optimize a policy graph, with restricted width, for each agent. These methods compute a policy for a single belief, instead of all possible beliefs. Beliefs over world states are sampled centrally using various action heuristics. Policy graphs are built by dynamic programming from horizon T to the first time step. At each time step, a policy is computed for each policy graph node, by assuming that the nodes all agents are in are associated with the same belief. In a POMDP, computing the deterministic policy for a policy graph node means finding the best action, and the best connection (best next node) for each observation; this can be done with a direct search. In a DEC-POMDP, this approach would go through all combinations of actions, observations and next nodes of all agents: the number of combinations grows exponentially with the number of agents, so direct search works only for simple problems. A more efficient way is to go through all action combinations, for each action combination sample random policies for all agents, and then improve the policy of each agent in turn while holding the other agents' policies fixed. This is not guaranteed to find the best policy for a belief, but has yielded good results.

A new algorithm is introduced which improves on this. The equations for two agents are presented; extension to more agents is straightforward. The value function V(s,\vec{q}) is initialized to zero. An initial policy graph is constructed for each agent, starting from horizon t=T:(1) The initial belief is projected along a random trajectory to the horizon t to yield a sampled belief b(s) over world states. (2) For each agent, a node is added to the layer t (in the graph of that agent). For each action-combination \vec{a} the best observation connections to next layer nodes are searched for. The value of \vec{a} and the chosen observation connections can be computed using b(s) and the next layer value function. In the observation connection search, random connections to the next layer (each observation connects to a next layer node) are sampled first for each agent αᵢ. Then the agents are gone through until convergence: for \vec{a} and agent αᵢ the best next layer node for each possible observation is found, while holding other agents α_{j≠i} connections fixed. The action combination \vec{a} with the observation connections with largest value are chosen as the policy for the current policy graph node. Random restarts are used to escape local minima. (3) Steps (1) and (2) are performed until the policy graph layer has the desired number of nodes. (4) t is decremented and (1)-(3) performed again until t=0.

After initialization, a more advanced optimization is used: (1) A random trajectory is not used for belief projection, instead the initial belief b(s,\vec{q}) is projected over world states s and controller nodes \vec{q} (agents are initially assumed to start from the first controller node), from time step 1 to the horizon T, through the current policy graph. This yields distributions for the FSC nodes that match the current policy. (2) We start from the last layer and proceed towards the first. At each layer, each agent is optimized separately, as follows. For each graph node q₀ of agent 1, for each action of the agent, and for each observation o₁, the (deterministic) connection to the next layer, that is, the deterministic transition probabilities P(q′ᵢ|q₁=q₀,o₁), is optimized by maximizing value as follows. Denoting h_{\vec{o}s′s\vec{a}\vec{q}\vec{q}}=P(\vec{o},s′|s,\vec{a})b(s,q₁=q₀,q₂)P₁(q′₁|o₁)P(q′₂|q₂,o₂)V(s′,\vec{q}′) the connection for each observation maximizes the contribution of that observation to the value, Σ_{s,s′,o}_{₂}_{,q}_{₂}_{,\vec{q}}h_{\vec{o}s′s\vec{a}\vec{q}\vec{q}}, and the action maximizes V(b,q₀)=Σ_{s,q}_{₂}b_{s,q}_{₀}_{,q}_{₂}R_{s\vec{a}}+γΣ_{s,s′,\vec{o},q}_{₂}_{,\vec{q}″}h_{\vec{o}s′s\vec{a}\vec{q}\vec{q}′} where we sum over the possible nodes q₂ of other agents, and the action of agent 1 is part of the joint action \vec{a} where the actions of other agents are the ones chosen by their current policies for the belief b. (3) If the optimized policy at the node (action and connections) is identical to policy π of another node in the layer, a new belief is sampled over world states, and the node is re-optimized for the new belief. If no new policy is found even after trying several sampled beliefs, several uniformly random beliefs are tried for finding policies. Any connections from the previous policy graph layer to the current node are redirected to go instead to the node having policy π; this “compresses” the policy graph without changing its value (in POMDPs the redirection step is not necessary, it will happen naturally when the previous layer is re-optimized). (4) We proceed backward through layers to the first layer.

An exemplary improvement of the instant finite-horizon method over other techniques is the policy improvement stage, where beliefs are projected through the graph, and connections and actions are optimized. This gets rid of the simplifying assumption that all FSCs are in the same node, for a certain belief, made in other technique. Herein, this assumption is only used for initialization steps, but not in actual optimization. The instant optimization monotonically improves the value of a fixed size policy graph. Here the procedure was applied to finite-horizon DEC-POMDPs; the procedure is adapted for improving deterministic infinite-horizon FSCs in “Deterministic infinite-horizon controllers”. Two improvements have also been added. (1) A speedup has been added: other techniques used linear programming to find policies for each agent and action-combination in turn, but with a fixed joint action and fixed policies of other agents, simple direct search is faster, and the instant techniques use the simple direct search. (2) Improved duplicate handling has been added: other techniques tried sampled beliefs to avoid duplicate nodes; herein, uniformly random beliefs are also tried, and for DEC-POMDPs previous-layer connections are re-directed to duplicate nodes.

The instant improved procedure differs from the “recursion” idea in other techniques, where a computed policy graph is used to choose actions during a new iteration of belief sampling; here, the policy is not for sampling, instead, the distribution is projected over both world state and controller nodes forward. The instant projection approach is guaranteed to improve the value of each graph node and hence the policy.

Deterministic Infinite-Horizon Controllers

To initialize an infinite-horizon problem, a deterministic finite-horizon policy graph (resulting from the method of the previous section) is transformed into an infinite-horizon periodic controller by connecting the last layer to the first one. Assuming controllers start from policy graph node 1, first policies can be computed for the other nodes in the first layer with beliefs sampled for time step M+1, where M is the length of the controller period. It remains to compute the (deterministic) connections from the last layer to the first layer: approximately optimal connections are found using the beliefs at the last layer and the value function projected from the last layer back through the graph to the first layer. This approach can produce efficient controllers on its own, but may not be suitable for problems with a long effective horizon.

The initialized infinite-horizon periodic policy can be improved by optimizing in a similar fashion as in “Deterministic finite-horizon controllers”. An effective projection horizon Tₚᵣₒⱼ is first determined, and then the policy is optimized given the projection horizon. The projection horizon can be determined while computing a Q_{MDP} policy in other techniques, which is an upper bound to the optimal DEC-POMDP policy, using dynamic programming. The number of dynamic programming steps is used as the projection horizon: this is the number of steps it takes to gather enough value in the corresponding MDP.

Given the projection horizon, the deterministic periodic policy is optimized: for each periodic FSC layer, a discounted sum of beliefs is computed from the projected beliefs. The next time step value function for a policy graph layer is computed by backing up M−1 steps from the previous periodic FSC layer to the next FSC layer. A layer of the periodic FSC is then improved using the computed belief and value function according to the procedure described in “Deterministic finite-horizon controllers”. After sufficient iterations of policy improvement, the resulting deterministic policy can be used as is, or the policy can be used as initialization to the stochastic periodic controller described next.

Stochastic Infinite-Horizon Controllers and Expectation Maximization Training

A stochastic FSC can provide a solution of equal value compared to a deterministic FSC with a smaller number of controller nodes. Stochastic controllers have been successful in many different problems. Many algorithms that optimize stochastic FSCs could be adapted to use periodic FSCs; in this document, the expectation-maximization approach is adapted to periodic FSCs.

In the expectation maximization (EM) approach in other techniques, the optimization of policies is written as an inference problem: rewards are scaled into probabilities and the policy, represented as a stochastic FSC, is optimized by EM iteration to maximize the probability of getting rewards. An EM algorithm is now introduced for (DEC-)POMDPs with periodic stochastic FSCs. First, the reward function is scaled into a probability \hat{R}(r=1|s,\vec{a})=(R(s,\vec{a})−Rₘᵢₙ)/(Rₘₐₓ−Rₘᵢₙ), where Rₘᵢₙ and Rₘₐₓ are the minimum and maximum rewards possible and \hat{R}(r=1|s,\vec{a}) is the conditional probability for the binary reward r to be 1. The FSC parameters θ are optimized by maximizing the reward likelihood Σ_{T=0}^{∞}P(T)P(r=1|T,θ) with respect to θ, where the horizon is infinite and P(T)=(1−γ)γ^{T}. This is equivalent to maximizing expected discounted reward in the DEC-POMDP. The EM approach improves the policy, i.e. the stochastic periodic finite state controllers, in each iteration. The E-step and M-step formulas are described next.

In the E-step, alpha messages \hat{α}^{(m)}(\vec{q},s) and beta messages \hat{β}^{(m)}(\vec{q},s) are computed for each layer of the periodic FSC. Intuitively, \hat{α}(\vec{q},s) corresponds to the discount weighted average probability that the world is in state s and FSCs are in nodes \vec{q}, when following the policy defined by the current FSCs, and \hat{β}(\vec{q},s) is intuitively the expected discounted total scaled reward, when starting from state s and FSC nodes \vec{q}. The alpha messages are computed by projecting an initial nodes-and-state distribution forward, while beta messages are computed by first projecting reward probabilities backward. Separate \hat{α}^{(m)}(\vec{q},s) and \hat{β}^{(m)}(\vec{q},s) are computed for each layer m. A projection horizon T=MT_{M}−1 is used, where MT_{M} is divisible by the number of layers M. This means that when enough probability mass has been accumulated in the E-step, a few steps are still projected in order to reach a valid T. For a periodic FSC, the forward projection of the joint distribution over world and FSC states from time step t to time step t+1 is Pₜ(\vec{q}′,s′|\vec{q},s)=Σ_{\vec{o},\vec{a}}P_{s′s\vec{a}}P_{\vec{o}s′\vec{a}}Πᵢ[πₐ_{ᵢ}_{q}_{ᵢ}^{(t)}λ_{q′}_{_{ĩ}}_{q}_{_{ĩ}}ₒ_{_{ĩ}}^{(t)}]. Each \hat{α}^{(m)}(\vec{q},s) can be computed by projecting a single trajectory forward starting from the initial belief and then adding only messages belonging to layer m to each \hat{α}^{(m)}(\vec{q},s). In contrast, each \hat{β}^{(m)}(\vec{q},s) has to be projected separately backwards, a “starting point” similar to the alpha messages does not exist. Denoting such projections by β₀^{(m)}(\vec{q},s)=Σ_{\vec{a}}\hat{R}_{s\vec{a}}Πᵢπₐ_{ᵢ}_{q}_{ᵢ}^{(m)} and βₜ^{(m)}(\vec{q},s)=Σ_{s′,\vec{q}′}βₜ₋₁^{(m)}(\vec{q}′,s′)Pₜ(\vec{q}′,s′|\vec{q},s) the equations for the messages become (Equation 1):

$${\hat{α}}^{( m )} ( \vec{q} , s ) = {\sum }_{{t}_{m} = 0}^{{T}_{M} - 1} {γ}^{( m + {t}_{m} M )} ( 1 - γ ) {α}_{( m + {t}_{m} M )} ( \vec{q} , s ) and$$

$${\hat{β}}^{( m )} ( \vec{q} , s ) = {\sum }_{t = 0}^{T} {γ}^{t} ( 1 - γ ) {β}_{t}^{( m )} ( \vec{q} , s ) .$$

This means that the complexity of the E-step for periodic FSCs is M times the complexity of the E-step for usual FSCs, with a total number of nodes equal to the width of the periodic FSC. The complexity increases linearly with the number of layers.

In the M-step, the action and transition parameters of each layer are updated separately using the alpha and beta messages computed in the E-step for that layer, as follows. EM maximizes the expected complete log-likelihood Q(θ,θ*)=Σ_{T}Σ_{L}P(r=1,L,T|θ)log P(r=1,L,T|θ*), where L denotes all latent variables: actions, observations, world states, and FSC states, θ denotes previous parameters, and θ* denotes new parameters. For periodic FSCs P(r=1,L,T|θ) is (Equation 2):

$$P ( r = 1 , L , T \vert θ ) = {{P ( T ) [ {\hat{R}}_{s \vec{a}} ]}_{t = T} [ {\prod }_{t = 1}^{T} {τ}_{\vec{a} \vec{q}}^{( t )} {P}_{{s}^{′} s \vec{a}} {P}_{\vec{o} {s}^{′} \vec{a}} {Λ}_{{\vec{q}}^{′} \vec{q} \vec{o} t} ] [ {τ}_{\vec{a} \vec{q}}^{( 0 )} {b}_{0} ( s ) ]}_{t = 0}$$

where we denoted τ_{\vec{a}\vec{q}}^{(t)}=Πᵢπₐ_{ᵢ}_{q}_{ᵢ}^{(t)} for t=1, . . . , T, τ_{\vec{a}\vec{q}}⁽⁰⁾=Πᵢπₐ_{ᵢ}_{q}_{ᵢ}⁽⁰⁾ν_{q}_{ᵢ}, and Λ_{\vec{q}′\vec{q}\vec{o}t}=Πᵢλ_{q′}_{ᵢ}_{q}_{ᵢ}ₒ_{ᵢ}^{(t-1)}.

The log in the expected complete log-likelihood Q(θ,θ*) transforms the product of probabilities into a sum; the sums can be divided into smaller sums, where each sum contains only parameters from the same periodic FSC layer. Denoting f_{s′s\vec{q}′\vec{o}\vec{a}m}=P_{s′s\vec{a}}P_{\vec{o}s′\vec{a}}\hat{β}^{(m+1)}(\vec{q}′,s′), the M-step periodic FSC parameter update rules can then be written as (Equation 3):

$${v}_{{q}_{i}}^{*} = \frac{{v}_{{q}_{i}}}{{C}_{i}} {\sum }_{s , {q}_{\tilde{i}}} {\hat{β}}^{( 0 )} ( \vec{q} , s ) {v}_{{q}_{\tilde{i}}} {b}_{0} ( s ) , \qquad ( 3 )$$

$$\begin{matrix}{π}_{{a}_{i} {q}_{i}}^{* ( m )} = \frac{{π}_{{a}_{i} {q}_{i}}^{( m )}}{{C}_{{q}_{i}}} {\sum }_{s , {s}^{′} {q}_{\tilde{i}} , {\vec{q}}^{′} , \vec{o} , {a}_{\tilde{i}}} \{ {\hat{α}}^{( m )} ( \vec{q} , s ) {π}_{{a}_{\tilde{i}} {q}_{\tilde{i}}}^{( m )} \cdot [ {\hat{R}}_{s \vec{a}} + \frac{γ}{1 - γ} {λ}_{{q}_{\tilde{i}}^{′} {q}_{\tilde{i}} {o}_{\tilde{i}}}^{( m )} {λ}_{{q}_{i}^{′} {q}_{i} {o}_{i}}^{( m )} {f}_{{s}^{′} s {\vec{q}}^{′} \vec{o} \vec{a} m} ] \} & ( 4 ) \\ {λ}_{{q}_{i}^{′} {q}_{i} {o}_{i}}^{* ( m )} = \frac{{λ}_{{q}_{i}^{′} {q}_{i} {o}_{i}}^{( m )}}{{C}_{{q}_{i} {o}_{i}}} {\sum }_{s , {s}^{′} {q}_{\tilde{i}} , {q}_{\tilde{i}}^{′} , {o}_{\tilde{i}} , \vec{a}} {\hat{α}}^{( m )} ( \vec{q} , s ) {π}_{{a}_{\tilde{i}} {q}_{\tilde{i}}}^{( m )} {π}_{{a}_{i} {q}_{i}}^{( m )} {λ}_{{q}_{\tilde{i}}^{′} {q}_{\tilde{i}} {o}_{\tilde{i}}}^{( m )} {f}_{{s}^{′} s {\vec{q}}^{′} \vec{o} \vec{a} m} .. & ( 5 )\end{matrix}$$

Note about Initialization

The initialization procedure (Sections “Deterministic finite-horizon controllers” and “Deterministic infinite-horizon controllers”) yields deterministic periodic controllers as initializations; a deterministic finite state controller is a stable point of the EM algorithm, since for such a controller the M-step of the EM approach does not change the probabilities. To allow EM to escape the stable point and find even better optima, noise is added to the controllers in order to produce stochastic controllers that can be improved by EM.

Experimental Results

Experiments were run for standard POMDP and DEC-POMDP benchmark problems. For both types of benchmarks, the proposed deterministic infinite-horizon method (denoted “Peri”) was run with nine deterministic improvement rounds as described in the section above entitled “Deterministic infinite-horizon controllers”. For DEC-POMDP benchmarks (see FIG. 9), the proposed stochastic infinite-horizon method (denoted “PeriEM”) was run, initialized by transforming the finite-horizon result, optimized with nine deterministic improvement rounds and further improved using periodic EM. A period of 30 was used for problems with discount factor 0.9, 60 for discount factor 0.95, and 100 for larger discount factors. The main comparison methods EM (from Kumar, A. and Zilberstein, S. Anytime, “Planning for Decentralized POMDPs using Expectation Maximization”, in Proc. of 26th UAI, (2010)) and Mealy NLP (from Amato, C. and Bonet, B. and Zilberstein, S., “Finite-State Controllers Based on Mealy Machines for Centralized and Decentralized POMDPs”, in Proc. of AAAI Conference on Artificial Intelligence (2010)) (with removal of dominated actions and unreachable state-observation pairs) were implemented using Matlab and the NEOS server was utilized for solving the Mealy NLP non-linear programs. The optimal number of FSC nodes was determined by trying out. EM was run for all problems and Mealy NLP for the Hallway2, decentralized tiger, recycling robots, and wireless network problems. We also report results from literature.

Table 1 (in FIG. 9) shows DEC-POMDP results for the decentralized tiger, recycling robots, meeting in a grid, wireless network co-operative box pushing, and stochastic mars rover problems. A discount factor of 0.99 was used in the wireless network problem and 0.9 in the other DEC-POMDP benchmarks. Table 2 (see FIG. 10) shows POMDP results for the benchmark problems Hallway2, Tag-avoid, Tag-avoid repeat, and Aloha. A discount factor of 0.999 was used in the Aloha problem and 0.95 in the other POMDP benchmarks. Methods whose 95% confidence intervals overlap with that of the best method are shown in bold. The proposed deterministic periodic method “Peri” performed best in five problems, and second best in two. It was the most consistently well-performing method. It performed exceptionally well in the challenging DecTiger problem. PeriEM also performed well, outperforming EM, but the deterministic Peri was even better.

### CONCLUSION

A new class of finite state controllers, periodic finite state controllers (periodic FSCs), was introduced and methods were presented for initialization and policy improvement. The resulting periodic methods yielded state of the art results in comparisons on POMDP and DEC-POMDP problems.

The period length was chosen based simply on the discount factor, which already performed very well. Even better results could be achieved, e.g., by running solutions of different periods in parallel.

In addition to the expectation-maximization presented here, other optimization algorithms for infinite-horizon problems could also be adapted to periodic FSCs: for example, the non-linear programming approach (see Amato, C. and Bernstein, D. and Zilberstein, S., “Optimizing Memory-Bounded Controllers for Decentralized POMDPs”, in Proc. of 23rd UAI, pages 1-8 (2007)) could be adapted to periodic FSCs. In brief, a separate value function and separate FSC parameters would be used for each time slice in the periodic FSCs, and the number of constraints would grow linearly with the number of time slices.

This ends the example.

Many current systems of communication involve protocols such as WLAN that can be roughly described as manually designed access policies. Such handcrafted policies work reasonably well but they have not been designed to be mathematically optimal for a given communication scenario. Within a fixed handcrafted policy, adaptation to different situations is limited by the expressiveness of the policy and the quality of such adaptation depends on how well the (often human) creator of the policy anticipated the needs of different situations and on how well the creator was able to handcraft policy parameters for very complicated situations.

In the techniques presented herein, policies are not handcrafted (unless, e.g., business reasons restrict part of the policies from being freely optimized). Instead, the policies are found in exemplary embodiments as the result of complicated optimization performed by computing devices, some of which can be central communicating devices, some of which are individual devices like cell phones. Some parts of the computation that do not depend much on situation-dependent knowledge could also be performed by off-site computing resources. The point of creating policies based on complicated optimization is to find policies that model the communication scenario as a probabilistic series of events and then adjust the access policies to maximize concrete quantitative goodness functions. That is, such policies are optimal for the communication scenario, at least up to how well the probabilistic model can represent the communication, up to the limits of the functional forms of the policies, and up to the ability of optimization methods to reach the optimum. In this sense, such policies are much more adaptive than handcrafted policies.

In particular, note that a communication scenario with several communicating devices could turn out to have very complicated regularities in the access patterns of devices. For a simple example, it could turn out that, after being silent for long, Device 1 typically accesses its current channel with a particular send-wait-listen pattern. For example, “send send wait wait listen send listen send wait listen send listen” (where each word indicates an action in a short, discrete time slot). On the other hand, after a long sequence of transmissions, the device would use another access pattern. Several other devices share the same channel or channels, and each of the other devices would have their own typical access patterns. Within this set of devices and their access patterns, there can be transmission opportunities that can be predicted by probabilistic modeling: the resulting access rules can be far more complicated than what normal handcrafted access policies can represent. Thus, finding complicated policies by methods like described above is essential for achieving higher efficiency in complicated communication situations.

Although the exemplary embodiments of the invention use periodicity, techniques using periodicity may go beyond the abilities of simple scheduled access. Exemplary embodiments herein are about at least partly cognitive methods of access, that is, the policies used by devices might not be simply “do not access during this interval”. Instead, the devices will use different probabilistic sensing and transmission patterns during different intervals based on the results of mathematical optimization and probabilistic modeling of each situation. Furthermore, in one example of the current invention, a central device can communicate periodic restrictions of behavior to individual devices: even this need not be simple “access or not” restrictions but for example restrictions like “access only using normal protocols” or “use cognitive methods only ⅓ (one-third) of the time, otherwise use normal protocols”. For example, a company that uses a lot of old non-cognitive transmission hardware might allow others operating in the nearby area to use the same channel, if they fall back to old protocols when the company's hardware periodically uses the channel. Such restrictions could be part of the information transmitted in our invention. In this way, the techniques presented herein may reach beyond simple scheduled access.

Previous cognitive methods can have problems due to quickly growing computational complexity; the techniques presented herein mitigate the problem by intelligent restriction of model structure and by proposing a system of gathering and sharing information so that the model structure is chosen well for each communication situation.

The instant approach can adapt to crucially more complex and more varying situations than previous approaches. For instance, exemplary techniques herein can optimize periodic stochastic policies for multiple wireless devices. Even if there is no external periodic interference source, wireless devices cause interference to each other. By restricting the policies to a periodic structure, techniques presented herein can create stochastic wireless device policies, which have the advantages of both scheduled systems and random access systems.

In previous systems, periodicity was assumed to remain the same and the dynamics of the interfering system was very limited. That is, the periodic transmissions of “external” devices (as defined above) were detected and then the transmissions of an “internal” wireless devices were adjusted to transmit only when the external devices were not transmitting.

An exemplary embodiment herein can compute stochastic policies using periodicity information and a priori information, such as predefined rules. Further, in an exemplary embodiment, the wireless devices are assumed to have a common synchronized clock, which can be arranged in several known ways. For example by communication from a central system or another system, which system is known to all devices.

In an instant approach, using periodic information can reduce computational complexity compared to approaches that do not use periodic information, however computational complexity can still be higher than in traditional protocols. The distribution of computational burden varies in different implementations. Implementing a policy is typically computationally much easier than optimizing a policy.

Comparing to recent methods used in LTE/LTE-Advanced: such methods are still not cognitive in the sense that these methods are not computationally optimized for a particular communication situation. Instead, optimized (cognitive) policies could in principle therefore attain even better results. The LTE/LTE-Advanced channel access methods perform well, and some of their design could later be combined with the methods proposed here for an even better-performing hybrid system than the current system; or alternatively, the access policy that LTE/LTE-Advanced methods correspond to could be used as an intelligent initialization for optimization methods herein.

The exemplary methods can involve a lot of computation; however, situations can exist where the additional benefit of the optimized policy is worth the extra computation (as computation power of devices grows, such situations can become more common).

Some exemplary points of discussion are highlighted below:

[A]. Wireless resource access policies that are optimized (e.g., adapted) to a communication situation can be better than handcrafted access policies like WLAN.

[B]. Optimizing (e.g., adapting) a wireless resource access policy for a communication situation is a computational task which can be very involved and time-consuming. Several current suggestions are based on reinforcement learning methods like “partially observed Markov decision processes”, or “decentralized partially observed Markov decision processes” in cases where policies are optimized for multiple devices together. However, optimizing such policies is so slow that results reached in a finite time may not be as good as they could be; that is, the available time is not usually enough to reach the best optimum.

[C]. Optimization would be faster if the search was restricted to a particular form of policy. The inventors have noticed that in particular periodic policies are useful (periodic policies are policies where the behavior of a device cycles at a fixed pace through modes of behavior, which are called “layers” herein, and the precise behavior is determined by choosing particular controller nodes within layers). Restricting the optimization to periodic policies allows the optimization to proceed further in the limited time available, and therefore allows the optimization to produce better optimized (e.g., better adapted) policies for devices.

[D]. Using periodic policies only speeds up optimization if the algorithms that perform the optimization can take advantage of the periodic structure of the policies. Specific algorithms were introduced above, and these show how the periodic structure can be taken into account to speed up the optimization. The introduced algorithms are faster because the periodic restriction has been taken into account. Other existing algorithms could be modified in a similar manner, to achieve similar speedups.

[E]. The quicker optimization (relative to other optimization methods) depends on the restriction to a periodic policy. Before the optimization, the structure of the periodic policy must be determined. How well the periodic structure matches the real communication situation will determine how good the resulting wireless resource access policies are. The structure of the periodic policy could be assigned by simple heuristics as is done in the algorithms above. However, it would be even better to optimize the structure too. In an exemplary embodiment of the instant invention, it is suggested that the structure would be optimized in a simple manner, for example by a central device, which has observed the communication in the local environment for a long time and has been able to notice periodic trends in the communication.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., device) that may be any media or means that can contain or store the instructions for use by or in connection with an instruction execution system, apparatus, or device, such as a computer.

In an exemplary embodiment, an apparatus is disclosed that comprises means for accessing a periodic finite state controller embodying a set of policies for at least access to one or more wireless resources used for transmission by the apparatus; and means for using the accessed periodic finite state controller to transmit information using the one or more wireless resources.

In another exemplary embodiment, an apparatus comprises means for determining a period based at least on characteristics of a wireless environment; and means for using at least the determined period and the characteristics, determining a periodic finite state controller embodying a set of policies for at least access to one or more wireless resources used for transmission in the wireless environment by a selected wireless device.

Without in any way limiting the scope, interpretation, or application of the claims appearing below, a technical effect of one or more of the example embodiments disclosed herein is determining, providing, and/or using communication rules in the form of periodic FSCs. Another technical effect of one or more of the example embodiments disclosed herein is using periodicity in a wireless environment to improve optimization of access policies for wire resources.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims

1. An apparatus, comprising:
one or more processors; and
one or more memories including computer program code,
the one or more memories and the computer program code configured to, with the one or more processors, cause the apparatus to perform at least the following:
accessing a periodic finite state controller embodying a set of policies for at least access to one or more wireless resources used for transmission by the apparatus; and
using the accessed periodic finite state controller to transmit information using the one or more wireless resources.

2. The apparatus of claim 1, where the periodic finite state controller comprises a plurality of layers, each layer corresponding to a time interval of a period and comprising one or more nodes, each node corresponding to a state of the apparatus, where individual ones of the nodes are connected to one or more other nodes through transitions, where the layers are ordered from a beginning layer to an ending layer and occupy the period, where transitions between nodes occur between layers but not within a layer, and where the transitions between nodes occur only from lower-ordered layers to higher-ordered layers except for nodes in the ending layer, the nodes in the ending layer having transitions to nodes in the beginning layer.

3. The apparatus of claim 2, where each node has at least one action and at least one of the transitions has an assigned probability of causing that at least one transition to be taken by the apparatus.

4. The apparatus of claim 1, where the one or more memories and the computer program code are further configured to, with the one or more processors, cause the apparatus to perform at least the following:
receiving information allowing the periodic finite state controller to be determined; and
determining the periodic finite state controller based on the received information.

5. The apparatus of claim 1, where the periodic finite state controller is a complete periodic finite state controller, and where the one or more memories and the computer program code are further configured to, with the one or more processors, cause the apparatus to perform at least the following:
receiving information allowing a portion of the periodic finite state controller to be determined;
determining the portion of the periodic finite state controller based on the received information; and
optimizing the portion of the periodic finite state controller to create the complete periodic finite state controller.

6. The apparatus of claim 1, where the periodic finite state controller is a complete periodic finite state controller, and where the one or more memories and the computer program code are further configured to, with the one or more processors, cause the apparatus to perform at least the following:
receiving information corresponding to a description of periodicity characteristics of a wireless environment in which the apparatus operates and a corresponding period, the corresponding period being a period to which the periodic finite state controller corresponds; and
determining and optimizing the periodic finite state controller based at least on the received information.

7. The apparatus of claim 5, where optimizing further comprises determining periodicity of interference affecting communication between wireless devices in a wireless environment in which the apparatus operates and using the determined periodicity to determine the complete periodic finite state controller.

8. The apparatus of claim 5, where optimizing further comprises determining transmitter characteristics of a plurality of wireless devices in the wireless environment and using the determined transmitter characteristics to determine the complete periodic finite state controller.

9. The apparatus of claim 5, where the apparatus further comprises a transmitter and a corresponding transmitter buffer, and where optimizing further comprises determining a pattern by which the input buffer of the transmitter fills up and using the determined pattern to determine the complete periodic finite state controller.

10. A method, comprising:
accessing a periodic finite state controller embodying a set of policies for at least access to one or more wireless resources used for transmission by a wireless device; and
using the accessed periodic finite state controller to transmit by the wireless device information using the one or more wireless resources.

11.-19. (canceled)

20. An apparatus, comprising:
one or more processors; and
one or more memories including computer program code,
the one or more memories and the computer program code configured to, with the one or more processors, cause the apparatus to perform at least the following:
determining a period based at least on characteristics of a wireless environment; and
using at least the determined period and the characteristics, determining a periodic finite state controller embodying a set of policies for at least access to one or more wireless resources used for transmission in the wireless environment by a selected wireless device.

21. The apparatus of claim 20, where the periodic finite state controller comprises a plurality of layers, each layer corresponding to a time interval of the period and comprising one or more nodes, each node corresponding to a state of the selected wireless device, where individual ones of the nodes are connected to one or more other nodes through transitions, where the layers are ordered from a beginning layer to an ending layer and occupy the period, where transitions between nodes occur between layers but not within a layer, and where the transitions between nodes occur only from lower-ordered layers to higher-ordered layers except for nodes in the ending layer, the nodes in the ending layer having transitions to nodes in the beginning layer.

22. The apparatus of claim 21, where:
each node has at least one action and at least one of the transitions has an assigned probability of causing that at least one transition to be taken by the selected wireless device; and
determining a periodic finite state controller further comprises determining the at least one action for each node and the at least one transition in order to meet the embodied set of policies.

23. The apparatus of claim 20, where the one or more memories and the computer program code are further configured to, with the one or more processors, cause the apparatus to perform at least the following:
transmitting information to the selected wireless device, the information allowing the selected wireless device to determine at least a portion of the periodic finite state controller.

24. The apparatus of claim 20, where the characteristics comprise periodicity of interference affecting communication between wireless devices in the wireless environment.

25. The apparatus of claim 20, where the characteristics comprise transmitter characteristics of a plurality of wireless devices in the wireless environment.

26. The apparatus of claim 25, where the transmitter characteristics further comprise one or both of a stochastic interference pattern caused by transmitters of the plurality of wireless devices or a pattern by which input buffers of the transmitters fill up.

27. The apparatus of claim 20, wherein:
determining the periodic state controller further comprises determining a plurality of periodic finite state controllers embodying the set of policies for at least access to the one or more wireless resources used for transmission in the wireless environment by a plurality of wireless devices including the selected device; and
where the one or more memories and the computer program code are further configured to, with the one or more processors, cause the apparatus to perform at least the following:
transmitting information to the selected wireless device, the information allowing the selected wireless device to determine at least a portion of a first of the plurality of periodic finite state controllers; and
transmitting information to a second selected wireless device, the information allowing the second selected wireless device to determine at least a portion of a second of the plurality of periodic finite state controllers.

28. The apparatus of claim 27, wherein a policy embodied in the first and second periodic finite state controllers creates a higher probability that one of the selected wireless device or the second selected wireless device will transmit while another of the selected wireless device or the second selected will wait.

29. The apparatus of claim 20, wherein at least one of the set of policies comprises limiting the selected wireless device to transmission at predetermined time periods.

30.-40. (canceled)
